(19) United States
(12) Patent Application Publication
(10) Pub. No.: US 2007/0059467 A1
(43) Pub. Date: Mar. 15, 2007

(54) Spirally wound tube with voids and method for manufacturing the same

(75) Inventor: Johannes Wilhelmus van de Camp, Hartsville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 11/225,547

(22) Filed: Sep. 13, 2005

(51) Int. Cl. B29C 70/08

(52) U.S. Cl. 428/36.3

(57) ABSTRACT

A spirally wound tube having an intermediate zone defining one or more voids and a method of making such a tube. The tube is made by spirally winding a plurality of plies and mini-plies together forming an inner zone, intermediate zone, and an outer zone. Each zone has one or more layers of plies or mini-plies. More specifically, each intermediate layer includes a number of mini-plies spirally wound with gaps between adjacent mini-plies. Furthermore, the intermediate layers are radially aligned with each other such that the gaps of each layer form voids. Each void has a radial height substantially equal to the radial height of the intermediate layers combined or the intermediate zone.

### FIELD OF INVENTION

The present invention relates generally to paperboard tube structures. More particularly, the invention relates to paperboard tube structures having a construction promoting an enhanced wall thickness and bending stiffness for a given mass of the tube structure.

### BACKGROUND OF THE INVENTION

Within the paperboard tube industry, it is desirable to minimize the amount of ply material used to manufacture a paperboard tube. Paperboard tube structures are often used in consumer good applications such as paper towel rolls or toilet paper rolls, but they are also used in manufacturing applications such as cores for supporting rolled sheet material or in industrial applications such as forms or templates for columnar structures.

Tube structures must possess structural properties commensurate with their intended applications. Paperboard tube designs and manufacturing procedures preferably should minimize the amount of raw materials needed to achieve the required structural properties for the particular tube structure. By reducing the material needed, the expense of producing the paperboard tube structures will likewise decrease.

The bending stiffness and other strength properties of tube structures depend on a number of factors, including the strength of the individual plies of the tube and the wall thickness of the tube. As a general rule, increasing the wall thickness of a tubular structure will result in a stronger tube. An increase in wall thickness can be brought about by using additional plies and/or using thicker plies. In either case, an additional amount of raw material is required, which increases the cost of the paperboard tube. Tube strength can also be increased by using denser, stronger plies, but such stronger plies are relatively more costly.

Therefore, a need exists for a paperboard tube structure requiring a minimal amount of paperboard material while maintaining adequate tube strength. Furthermore, it would be advantageous for such a structure to be the product of a cost effective process.

### BRIEF SUMMARY OF THE INVENTION

The present invention addresses the above needs and achieves other advantages by providing a spirally wound tube having an intermediate zone defining one or more voids and a method of making such a tube. In general, the tube is made by spirally winding a plurality of plies together. More specifically, a plurality of plies form an intermediate zone in the tube having one or more voids, each void having a radial height substantially equal to the radial height of the intermediate zone.

According to one embodiment of the present invention, the tube includes an inner zone, an outer zone, and an intermediate zone. The inner zone is located radially inwardly and includes at least one inner layer. Each inner layer has at least one inner ply. The inner ply or plies are spirally wound to form the inner layer. Similarly, the outer zone is located radially outwardly and includes at least one outer layer. Each outer layer has at least one outer ply. The outer ply or plies are spirally wound to form the outer layer. The intermediate zone is located between the outer zone and inner zone and includes at least one intermediate layer. Each intermediate layer includes more than one intermediate ply. The intermediate plies are spirally wound with gaps between adjacent plies of that intermediate layer. Moreover, the intermediate layers are radially aligned such that the gaps in every intermediate layer are aligned to each other and form voids. Each void has a thickness or radial height substantially equal to the thickness of the intermediate zone.

The width and thickness of the plies may vary. However, according to one preferred embodiment, the thickness of each inner ply, intermediate ply, and outer ply is substantially equal to each other. The width of each intermediate ply is substantially less than the width of each outer ply and inner ply.

In another embodiment of the present invention, the paper tube includes a plurality of paperboard plies spirally wound about an axis and adhered together to form a tube. The wall of the tube comprises an inner zone, an outward zone, and an intermediate zone. The inner zone is located radially inwardly and comprises at least one inner ply. The outer zone is located radially outwardly and comprises at least one outer ply. The intermediate zone is located between the inner zone and the outer zone and comprises a plurality of intermediate paperboard plies. The intermediate paperboard plies are aligned and wound one atop another such that a void exists between adjacent edges of consecutive turns of the intermediate paperboard plies. The thickness or radial height of each void is substantially equal to the thickness of the intermediate zone.

One aspect of the present invention is a method of constructing a paperboard tube with at least one void in its wall. The method includes spirally winding plies about a forming mandrel to form wall zones. In particular, one or more inner plies are spirally wound to form an inner tube wall zone. Two or more intermediate plies are spirally wound and aligned to form an intermediate wall zone with voids between adjacent edges of consecutive turns of the intermediate plies, wherein the radial height of each void is substantially equal to the radial height of the intermediate tube wall zone. Also, one or more outer plies are spirally wound to form an outer tube wall zone. The plies of the inner, intermediate, and outer wall zones are adhered together to form a tube.

According to another embodiment of the present invention, the method includes providing a plurality of plies. The width of each ply is substantially equal. One or more plies are applied to a forming mandrel with nominal gaps between adjacent edges of consecutive turns of each ply to form an inner tube zone. One or more plies are used to form more than one mini-ply. The width of each mini-ply is substantially less than the width of each ply. The mini-plies are applied in a radially aligned fashion to the forming mandrel with gaps between adjacent edges of consecutive turns of the mini-plies to form an intermediate tube zone with voids. The radial height or thickness of each void is substantially equal to the radial height or thickness of the intermediate tube zone. One or more the plies are applied to the forming mandrel with nominal gaps between adjacent edges of consecutive turns of each ply to form an outer tube zone.

In yet another embodiment, the method includes forming more than one intermediate layer. Each layer is formed by spirally winding a plurality of mini-plies. For example, the method includes forming four mini-plies out of one ply and spirally winding the four mini-plies to form one intermediate layer such that a gap exists between adjacent mini-plies. Further, the mini-plies in a given intermediate layer are radially aligned to form voids. Each void has a radial height substantially equal to a radial height of the entire intermediate zone.

Another aspect of the present invention is the forming of the mini-plies out of the one or more of the plies. The forming of the mini-plies may be accomplished using a variety of methods. For example, according to the preferred embodiment, the method further includes a step of perforating one or more of the plies to facilitate the forming of the mini-plies. More specifically, according to this embodiment, the forming of the mini-plies is accomplished by separating one or more of the plies into mini-plies along a perforation line. Alternatively, the forming of the mini-plies may be accomplished by using a water jet cutter or other means known in the art.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a tube according to one embodiment of the present invention, with the outer zone of the tube partially broken away to show the intermediate zone;

FIG. 2 is a cross-sectional view of the tube shown in FIG. 1 taken substantially along line 2-2, with the outer zone of the tube in place;

FIG. 3 is a diagrammatic top elevation of an apparatus for forming a tube as shown in FIGS. 1 and 2, showing mini-plies and plies being wound onto a forming mandrel;

FIG. 4 is a cross-sectional view as in FIG. 2 of a tube according to an alternative embodiment of the present invention;

FIG. 5 is a partial perspective view of an apparatus for forming the tube as shown in FIG. 4; and

FIG. 6 is an axial cross-sectional view of a portion of the apparatus and plies shown in FIG. 5 taken along line 6-6;

FIG. 7 is a cross-sectional view as in FIG. 2 of a tube according to another alternative embodiment of the present invention; and

FIG. 8 is a cross-sectional view as in FIG. 2 of a tube according to yet another alternative embodiment of the present invention.

### DETAILED DESCRIPTION OF THE INVENTION

The present invention now will be described more fully hereinafter with reference to the accompanying drawings, in which some but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

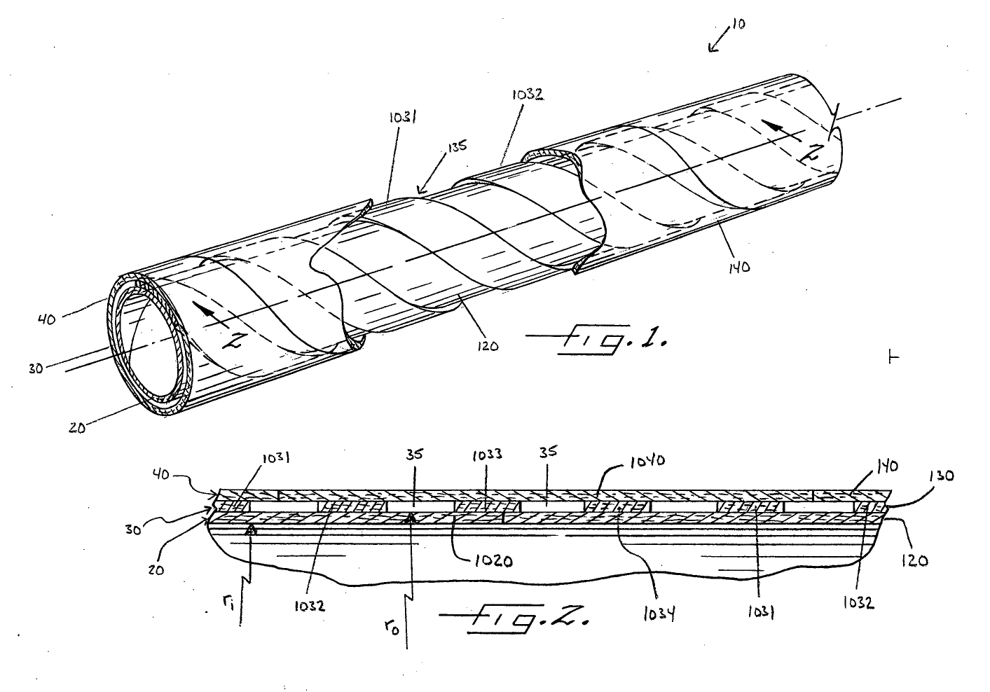

FIGS. 1 and 2 show a spirally wound tube 10 in accordance with one embodiment of the invention. The tube 10 has an inner zone 20, an intermediate zone 30, and an outer zone 40. Each zone 20, 30, 40 comprises one or more layers 120, 130, 140 (each zone in the FIG. 1 and 2 having only one layer), and each layer in turn comprises one or more plies or mini-plies. More specifically, the inner zone 20 is located inwardly and radially extends from (and thus defines) the inner diameter of the tube 10 to the intermediate zone 30. The intermediate zone 30 radially extends from the inner zone 20 to the outer zone 40. The outer zone 40 is located outwardly and radially extends from the intermediate zone 30 to (and thus defines) the outer diameter of the tube 10. The layer 130 of the intermediate zone 30 is different than the layers 120, 140 in either the inner or outer zones 20, 40. The layer 130 of the intermediate zone 30 comprises a plurality of plies that have gaps between consecutive turns of a ply or adjacent plies. In contrast, each of the layers 120, 140 of the inner zone 20 or outer zone 40 comprises only one ply wound with no substantial gaps, as further described below.

As used herein, a “layer” is a region of the tube 10 delimited by an outer radius rₒ and an inner radius rᵢ that respectively correspond to an outer surface and inner surface of a “ply” of that layer. A “ply” is a unitary sheet of material that, when wound into the tube 10, constitutes at least a part of a single layer of the tube 10. Thus, in accordance with the present invention, a layer can comprise more than one ply occupying the region bound by rₒ and rᵢ as best seen in FIG. 2.

According to one embodiment of the present invention and as shown in FIGS. 1 and 2, the inner zone 20 includes one layer 120 comprising one ply also referred to herein as an inner ply 1020 due to its location within the inner zone 20. The inner ply 1020 is wound so that nominally it has no substantial gaps between its adjacent edges along the length of the tube 10 as generally described in U.S. Pat. No. 6,851,643 to Qiu et al. and assigned to the same assignee as the present application, the entire contents of which are hereby incorporated by reference. “Nominally” means that the objective is to wind the inner ply 1020 so that a perfect butt joint exists between the adjacent edges. However, in practice, a perfect butt joint may not always be achieved, and typically small gaps are inadvertently created between the edges of the ply 1020. In general, such inadvertent gaps will be relatively small compared to the width of the plies.

Similarly, the outer zone 40 includes one layer 140 comprising one ply also referred to herein as an outer ply 1040 due to its location within the outer zone 40. The outer ply 1040 is wound so that nominally it has no substantial gaps between its adjacent edges along the length of the tube 10.

It should also be noted, as further described in U.S. Pat. No. 6,851,643, it is known from geometrical considerations applicable to spiral winding that to achieve a perfect butt joint, the width of ply, the diameter of the ply, and the spiral wind angle are related. Basically, the width, the angle, or both must increase as the diameter of the ply increases. Therefore, one in the art would appreciate that either the spiral wind angle, the width of the ply, or both may vary between layers to account for the above-mentioned geometrical considerations.

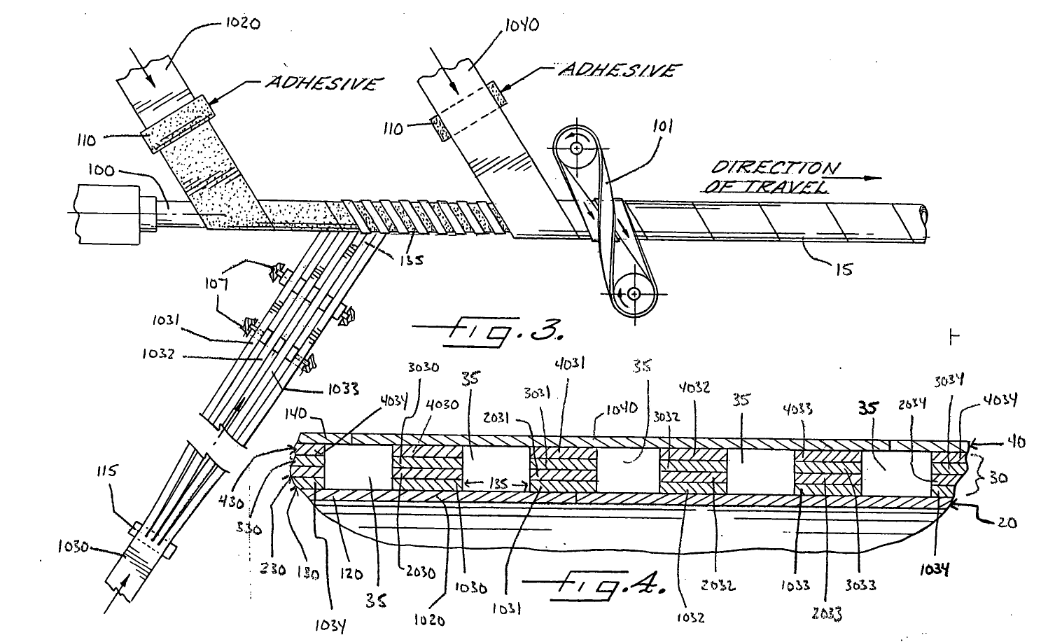

The intermediate zone 30 has one layer 130 comprising more than one mini-ply. For example purposes only and as seen in FIGS. 2 and 3, the intermediate layer 130 has four mini-plies 1031, 1032, 1033, 1034. The mini-plies 1031, 1032, 1033, 1034 are wound so a gap 135 is intentionally created between the mini-plies 1031, 1032, 1033, 1034 as best seen in FIG. 2. Preferably, for reasons explained further below, the four mini-plies 1031, 1032, 1033, 1034 are formed from a ply 1030 similar to the inner ply 1020 and the outer ply 1040. Each mini-ply 1031, 1032, 1033, 1034 has a width substantially less than the widths of the inner ply 1020 or the outer ply 1040. Also each gap 135 between mini-plies 1031, 1032, 1033, 1034 is substantially equal to the width of the mini-plies 1031, 1032, 1033, 1034.

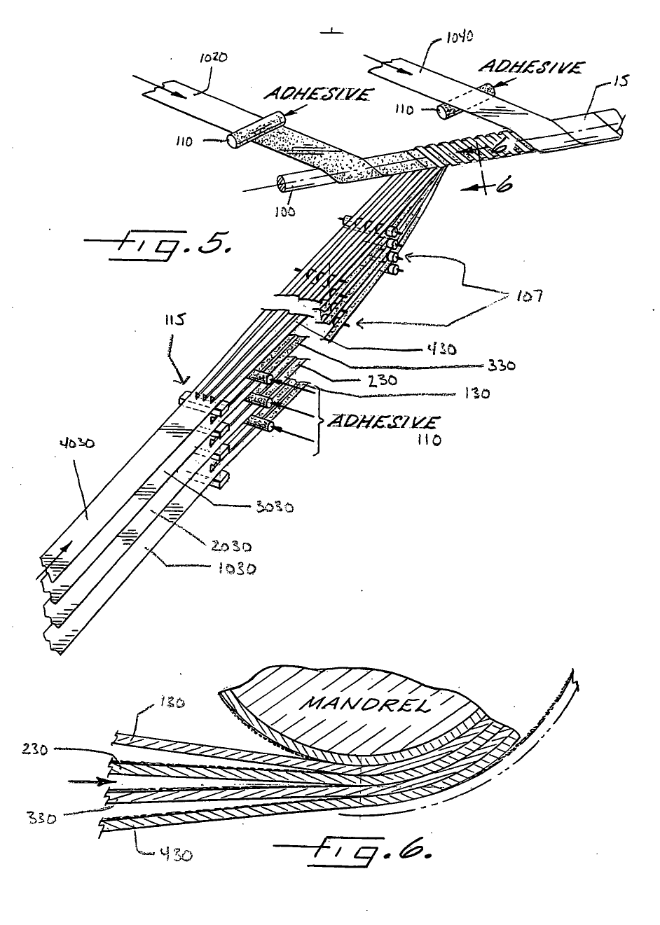

In an alternative embodiment, shown in FIGS. 4 and 5, the intermediate zone 30 has more than one intermediate layer. Although depicted in the figures as four intermediate layers 130, 230, 330, 430, the number of layers may vary. Each intermediate layer has more than one mini-ply. Again, for example purposes only, each intermediate layer 130, 230, 330, 430 may have four mini-plies 1030, 1031, 1032, 1033, 2030, 2031, 2032, 2033, 3030, 3031, 3032, 3033, 4030, 4031, 4032, 4033 intentionally wound so a gap 135, 235, 335, 435 is created between adjacent mini-plies in each layer. Also, the mini-plies in each intermediate layer 130, 230, 330, 430 are radially aligned with those of the other intermediate layers as best seen in FIG. 4. By radially aligning the mini-plies in the intermediate layers 130, 230, 330, 430, the gaps 135, 235, 335, 435 in each layer 130, 230, 330, 430 are aligned, forming voids 35 of larger radial height. More particularly, each void 35 has a radial height or thickness substantially equal to the radial height of the intermediate layers 130, 230, 330, 430 combined (i.e., the height of the intermediate zone 30). In theory, the radial height of each void 35 should be equal to the combined height of the intermediate layers 130, 230, 330, 430. However, in practice, the inner layer 120 or the outer layer 140 may sag into a void 35 or a void 35 may be partially filled with an adhesive.

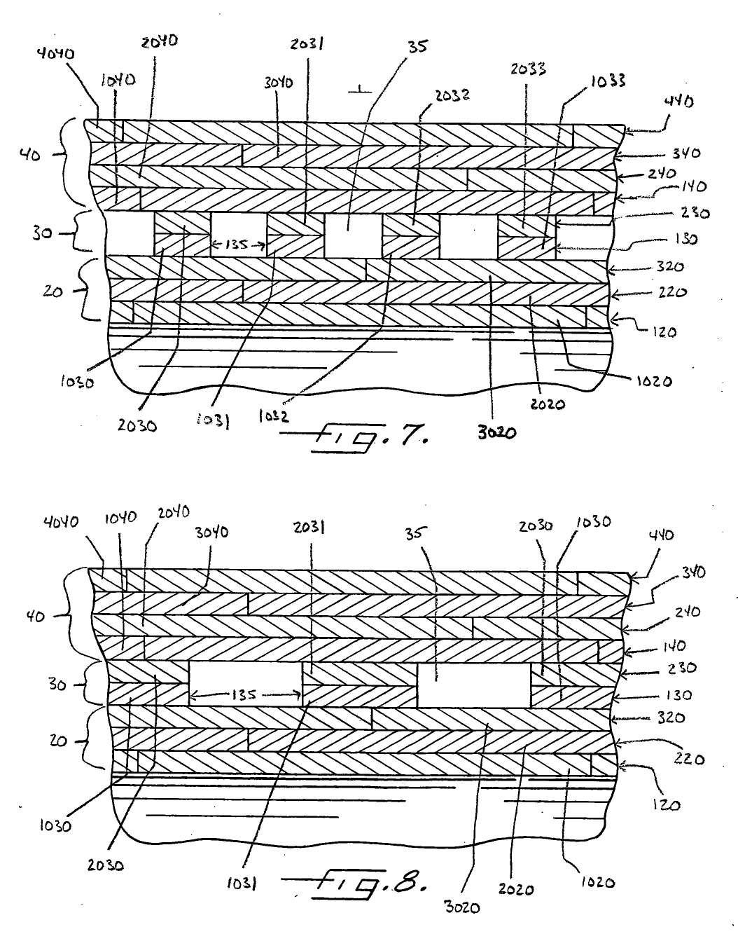

FIG. 7 illustrates yet another embodiment of the present invention. According to this embodiment, the inner zone 20 includes three layers 120, 220, 320. Each inner layer in turn includes one ply 1020, 2020, 3020. The outer zone 40 includes four layers 140, 240, 340, 440. Each outer layer in turn includes one ply 1040, 2040, 3040, 4040. The intermediate zone 30 includes two layers 130, 230. Each intermediate layer includes four mini-plies 1030, 1031, 1032, 1033, 2030, 2031, 2032, 2033. Between each adjacent mini-ply of an intermediate layer is a gap 135 approximately equal to the width of a mini-ply. Also, as described above, the intermediate layers 130, 230 are radially aligned, forming voids 35. The wound tube 10 according to this embodiment is referred to in the present specification and appended claims as a “4-spoke core” due to the number of mini-plies per intermediate layer.

FIG. 8 illustrates another alternative embodiment of the present invention. According to this embodiment, the inner zone 20 has three layers 120, 220, 320. The outer zone 40 has four layers 140, 240, 340, 440. Each layer of the inner zone and outer zone includes one ply 1020, 2020, 3020, 1040, 2040, 3040, 4040. The intermediate zone 30 includes two layers 130, 230. Each intermediate layer includes two mini-plies 1030, 1031, 2030, 2031. A wound tube 10 according to FIG. 8 is referred to in the present specification and appended claims as a “2-spoke core” due to the number of mini-plies per intermediate layer.

Wound tubes 10 having either the above-described 2-spoke core or the above-described 4-spoke core were constructed and tested for inner diameter stiffness. One in the art would appreciate that inner diameter stiffness is generally the resistance of the inner diameter to changes to its size due to radial pressure applied to the outer diameter. Inner diameter stiffness is described in more detail in U.S. Pat. No. 6,851,643 to Qiu et al. Typically, inner diameter stiffness is measured by psi per 0.001 inches, i.e., how much psi is required on the outer diameter to change the inner diameter by 0.001 inches.

The tested 4-spoke cores were constructed according to FIG. 7. In particular, each ply 1020, 2020, 3020, 1040, 2040, 3040, 4040 of the inner and outer layers was approximately 5 inches wide. Each mini-ply 1030, 1031, 1032, 1033, 2030, 2031, 2032, 2033 of the intermediate layers was approximately ⅝ inches wide. Also, each gap between adjacent mini-plies was approximately ⅝ inches wide. Therefore, the total width of the four mini-plies including the in-between gaps was approximately equal to the width of the plies in the outer and inner layers.

The tested 2-spoke cores were constructed according to FIG. 8. Specifically, each ply in the outer and inner layers was approximately 5 inches wide. Each mini-ply of the intermediate layers was approximately 1 ¼ inches wide. Each gap 135 between adjacent mini-plies was approximately 1¼ inches wide. Therefore the total width of the two mini-plies including the in-between gaps 135 was approximately equal to the width of the plies in the outer and inner layers.

One in the art would appreciate that the tested 4-spoke cores and 2-spoke cores as generally described-above have substantially the same weight and substantially the same amount of volume of voids. However the test results, shown in the table below, indicated that the 2-spoke cores had a higher inner diameter stiffness.

| Core type | 2 spoke | 4 spoke | units |
|---|---|---|---|
| ID | 3.025 | 3.028 | inch |
| wall | 0.180 | 0.190 | inch |
| ID stiffness | 50+ | 35 | psi/0.001″ |

(The test results take into account an 8% moisture content within the tubes.)

Another embodiment of the 2-spoke core was tested against a solid core. In general, a solid core, as referred to within this present specification and appended claims, is a conventional tube constructed without any mini-plies or significant gaps or voids between adjacent plies. However the solid core is constructed generally with the same material as the 2-spoke core and has substantially the same inner diameter and outer diameter. The 2-spoke cores and the solid cores were tested for inner diameter stiffness.

The results of the test are shown in the following table:

| Core type | 2 spoke | solid | units |
|---|---|---|---|
| ID | 3.078 | 3.073 | inch |
| wall | 0.331 | 0.336 | inch |
| weight | 39.31 | 48.71 | grams |
| ID stiffness | 110 | 53 | psi/0.001″ |

(Again, the test results take into account an 8% moisture content.)

The results show that the 2-spoke core outperformed the solid core in inner diameter stiffness. Also, as indicated, the 2-spoke core is approximately 20% lower in weight compared to a solid core.

Another aspect of the present invention is a method or process of forming the tube 10. In general, the tube 10 is formed by spirally winding a plurality of plies about a mandrel 100, adhering the plies together, and severing portions or sections of the spirally wound plies to form individual tubes 10. FIG. 3 illustrates one method of making the paper tube 10 according to one embodiment of the present invention. Three plies 1020, 1030, 1040 are drawn from respective creels (not shown) and routed along a path to the mandrel 100 by a series of guides. Each ply may have an adhesive applied to it at an adhesive applying station such as a glue pot. For example and as shown, adhesive is applied to the outwardly facing surface of the inner ply 1020 using an adhesive applicator 110 and the inner ply 1020 is spirally wound about the mandrel 100. A ply 1030 is provided for the intermediate layer 130. More specifically, the intermediate ply 1030 is routed toward the mandrel 100. Before the mandrel 100 but preferably after an adhesive applying station, the intermediate ply 1030 is separated into two or more mini-plies at a separation station 115. For example and as shown, the intermediate ply 1030 is split into four mini-plies 1031, 1032, 1033, 1034. Each mini-ply 1031, 1032, 1033, 1034 is routed to the mandrel 100 by a series of guides and spacers 107 to ensure proper alignment. The mini-plies 1031, 1032, 1033, 1034 are spirally wound around the mandrel 100 with gaps 135 between adjacent mini-plies 1031, 1032, 1033, 1034. Next, the outer ply 1040 is spirally wound around the mandrel 100 forming a continuous paper tube 15. A cut-off station (not shown) may be included to cut the continuous tube 15 into discrete lengths to form individual tubes 10. A winding belt 101 rotates the continuous tube 15 in a screw fashion such that the tube 15 advances down the mandrel 100.

As shown in FIGS. 5 and 6, the method may also include forming more than one intermediate layer 130, 230, 330, 430. When forming more than one intermediate layer 130, 230, 330, 430, the mini-plies 1030-1033, 2030-2033, 3030-3033, 4030-4033 of each layer 130, 230, 330, 430 are radially aligned so the gaps 135 of each layer 130, 230, 330, 430 form voids 35. Each void 35 has a radial height substantially equal to the combined radial height of the intermediate layers 130, 230, 330, 430. Radially aligning the mini-plies 1030-1033, 2030-2033, 3030-3033, 4030-4033 may be accomplished as shown in FIG. 5. The mini-plies formed from one ply may form one intermediate layer, and then the next layer of mini-plies formed from another ply may form the next intermediate layer, with the mini-plies from each layer stacked or aligned on each other. Alternatively, the mini-plies formed from one ply may be substantially stacked on top of each other as they are applied to the mandrel 100. In this alternative embodiment, each intermediate layer may have only one mini-ply.

The forming of mini-plies from one wider ply is one aspect of the present invention. This can be accomplished in several ways, for example with the use of water jet cutting. However, the preferred method is by perforating the plies. More specifically, one or more perforation lines, as best seen in FIGS. 3 and 5, are made in a ply. The perforating lines facilitate the separating or dividing of the ply into mini-plies. Perforating the ply can occur anywhere in the process, including at the paper mill. However, it is preferred for the separation of the plies into mini-plies to occur near the mandrel 100 and after the adhesive applying station 110. The wider body of the ply compared to the mini-plies makes it easier to ship, store, and process the perforated ply before it is separated into mini-plies (i.e., the wide perforated ply can be handled as an ordinary non-perforated ply and then can be separated into mini-plies just before winding onto the mandrel).

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A spirally wound tube, comprising:
an inner zone, an outer zone, and an intermediate zone;
the inner zone being located radially inwardly and including at least one inner layer, each inner layer including at least one inner ply, each inner ply having a width and thickness and being spirally wound;
the outer zone being located radially outwardly and including at least one outer layer, each outer layer including at least one outer ply, each outer ply having a width and thickness and being spirally wound; and
the intermediate zone being located between the outer zone and the inner zone and including a plurality of intermediate layers, each intermediate layer including at least one intermediate ply, each intermediate ply having a width and thickness and being spirally wound with gaps between adjacent edges of the intermediate ply of the intermediate layer;
wherein the intermediate plies of the intermediate layers are aligned such that the gaps in every intermediate layer are aligned to each other and form voids, each void having a thickness substantially equal to the thicknesses of the intermediate zone.

2. The tube according to claim 1, wherein the width of each inner ply is approximately equal to the width of each outer ply and the width of each intermediate ply is substantially less than the width of each inner ply or outer ply.

3. The tube according to claim 1, wherein the thickness of each immediate ply, the thickness of each inner ply, and the thickness of each outer ply are substantially equal.

4. The tube according to claim 1, wherein each intermediate layer comprises four intermediate plies.

5. A paper tube, comprising:
a plurality of paperboard plies being spirally wound about an axis and adhered together to form a tube, a wall of the tube comprising an inner zone, an outward zone, and a intermediate zone;
the inner zone being located radially inwardly and comprising at least one inner ply;
the outer zone being located radially outwardly and comprising at least one outer ply; and
the intermediate zone being located between the inner zone and the outer zone and comprising a plurality of intermediate paperboard plies,
the intermediate paperboard plies being aligned and wound one atop another such that a void exists between adjacent edges of consecutive turns of the intermediate paperboard plies wherein each void defines a radial height substantially equal to a radial height of the intermediate zone.

6. A method of constructing a paperboard tube defining at least one void within a cylindrical wall of the tube, the method comprising:
spirally winding from one to a plurality of inner plies about a forming mandrel to form an inner tube wall zone on the mandrel;
spirally winding and aligning a plurality of intermediate plies about the inner tube wall zone on the forming mandrel to form an intermediate tube wall zone with gaps between adjacent edges of consecutive turns of the intermediate plies so as to form voids in the intermediate tube wall zone, wherein the radial height of each void is substantially equal to the radial height of the intermediate tube wall zone;
spirally winding from one to a plurality of outer plies about the intermediate tube wall zone on the forming mandrel to form an outer tube wall zone; and
adhering the contiguous plies together to form a tube.

7. A method of making a spirally wound tube so as to form at least one void in a wall of the tube, the method comprising:
providing a plurality of plies, each ply defining a first width, wherein the first width of every ply is approximately equal;
spirally winding one or more of the plies about a forming mandrel with substantially zero gaps between adjacent edges of consecutive turns of each ply to form an inner tube zone;
forming a plurality of mini-plies out of one or more plies, each mini-ply having a second width less than the first width;
spirally winding the plurality of mini-plies in a radially layered and aligned fashion about the forming mandrel with gaps between adjacent edges of consecutive turns of the mini-plies to form an intermediate tube zone with voids, wherein each void defines a radial height substantially equal to the radial height of the intermediate tube zone; and
applying one or more of the plies to the forming mandrel with substantially zero gaps between adjacent edges of consecutive turns of each ply to form an outer tube zone.

8. The method according to claim 7 further including the step of perforating one or more of the plies to facilitate the forming of the mini-plies, wherein the forming of the mini-plies includes separating one or more of the plies along a perforation in the plies.

9. The method according to claim 7 wherein the forming of the mini-plies further includes using water jet cutting to separate one or more of the plies into min-plies.

10. A paper board tube comprising
one or more inner layers defining an inner zone of the tube, each inner layer including a spirally wound ply;
one or more outer layers defining an outer zone of the tube, each outer layer including a spirally wound ply; and
one or more intermediate layers defining an intermediate zone between the inner zone and the outer zone, each intermediate layer including a plurality of spirally wound plies.

11. The tube according to claim 10, wherein the plies in each of the intermediate layer are wound such that a gap exists between the adjacent plies of the layer and the gaps of each intermediate layer are aligned with the gaps in the other intermediate layers forming voids, such that each void defines a radial height substantially equal to a radial height of the intermediate zone.

12. The tube according to claim 10, wherein each gap defines a width and the width of each gap is substantially equal to the width of each ply of the intermediate zone.

13. The tube according to claim 10, where each ply defines a width and the width of the plies of the intermediate zone is substantially one fourth the widths of the plies in the outer zone.

14. A method of making a spirally wound tube so as to form at least one void in a wall of the tube, the method comprising:
spirally winding at least one inner ply to form at least one inner layer, wherein each inner layer has at least one of said one inner plies and the inner layers together define an inner zone of the tube;
forming a plurality of mini-plies out of at least one ply;
spirally winding a plurality of mini-plies to form at least one intermediate layer, wherein each intermediate layer has a plurality of mini-plies including gaps between adjacent mini-plies and the intermediate layers together define an intermediate zone of the tube; and
spirally winding at least one outer ply to form at least one outer layer, wherein each outer layer has at least one of said outer plies and the outer layers together define an outer zone of the tube.

15. The method according to claim 14, further comprising the step of forming four mini-plies for one ply and spirally winding the four mini-plies to shape one intermediate layer.

16. The method according to claim 14, wherein the mini-plies per intermediate layer are spirally wound such that each gap between adjacent mini-plies is approximately equal to a width of a mini-ply.

17. The method according to claim 16, wherein the gaps of each intermediate layer are radially aligned forming voids, such that each void defines a radial height substantially equal to a radial height of the intermediate zone.

18. The method according to claim 14, further including the step of perforating one or more of the plies to facilitate the forming of the mini-plies, wherein the forming of the mini-plies includes separating one or more of the plies along a perforation in the plies.

19. A method of making a spirally wound tube, comprising the steps of:
drawing a continuous ply from a supply and advancing the ply along a path toward a forming mandrel;
dividing the ply into a plurality of partial-width plies at a dividing station located along the path; and
spirally winding the partial-width plies about the mandrel.
